(19) United States
(12) Patent Application Publication
(10) Pub. No.: US 2011/0193032 A1
(43) Pub. Date: Aug. 11, 2011

(54) COMPOSITION FOR MAKING TRANSPARENT CONDUCTIVE COATING BASED ON NANOPARTICLE DISPERSION

(75) Inventor: Weili SHI, Highlandpark, NJ (US)

(73) Assignee: TECONA TECHNOLOGIES, INC., Highland Park, NJ (US)

(21) Appl. No.: 13/021,260

(22) Filed: Feb. 4, 2011

Related U.S. Application Data
(60) Provisional application No. 61/301,853, filed on Feb. 5, 2010.

(51) Int. Cl. H01B 1/12

(52) U.S. Cl. 252/519.21

(57) ABSTRACT

The present invention is directed to a composition for preparing transparent conductive coating on transparent substrate by an environment friendly method. An aqueous foam dispersion containing metal nanoparticles can form a transparent film by spontaneous self-assembly, which becomes conductive after sintering. The foam formulation contains mainly water without any toxic organic solvent.

This application claims benefit of U.S. Ser. No. 61/301,853, filed Feb. 5, 2010, the entire contents and disclosures of which are incorporated by reference into this application.

### FIELD OF THE INVENTION

This invention is directed to compositions and methods of incorporating metal nanoparticles into aqueous foam formulation/inks and applying the inks onto substrates to form transparent conductive coating. The resulting transparent and conductive layers are useful for thin film solar cells, touch screens, thin film transistor-liquid crystal display (TFT-LCD), plasma displays, organic light emitting diodes (OLED), EMI shielding, electrical papers (E-papers), flexible displays and other applications where optical transparency and electrical conductivity are desired.

### BACKGROUND OF THE INVENTION

Optically transparent and electrically conductive films are widely used in many kinds of electronic devices, such as thin film solar cell, touch screen, TFT-LCD, OLED, E-papers, EMI shielding, flexible displays and other applications where transparency and conductivity are required at the same time. Industry standard transparent conductor is indium-tin-oxide (ITO) film, which combines great transparency and conductivity. ITO films are generally formed on an electrical insulating substrate, such as glass or polyethylene terephthalate (PET), by Chemical Vapor Deposition (CVD) or Physical Vapor Deposition (PVD) including sputtering, ion plating and vacuum deposition. CVD or PVD produces a uniform coated film with good transparency and conductivity; however, it requires a complicated apparatus having a vacuum system and has poor productivity. It is exceptional expensive because of the use of vacuum chamber. It also requires subtractive patterning techniques, such as photolithography, to form highly conductive pattern, which are expensive, wasteful, and batch-oriented processes. The limited supply and high price of indium along with the characteristic delamination/fracture observed upon flexion make ITO unsuitable for the next generation of solar panels and display technologies. Other metal oxides, such as antimony-tin oxide (ATO), aluminum doped zinc oxide (AZO) and fluorine doped tin oxide (FTO) can also be used as cheaper alternative to ITO, but usually with inferior property, either less conductive or less transparent. Like ITO, they are manufactured by CVD or PVD and are easy to crack or break upon constant poking and flexion. Transparent conductive films made of single wall carbon nanotube (SWCNT) or graphene are flexible and can be formed by much cheaper liquid-processable techniques. However, the difficulty to manufacture pure SWCNT or graphene economically and the difficulty to purify these materials hindered the progress of using them as transparent conductor. Intrinsically conductive polymer is another option as transparent conductor. A commercially available conductive polymer is polyethylene dioxythiophene doped with polystyrene sulfonic acid (PEDOT:PSS), which is capable of being printed and deposited from solution at low temperatures and at a high rate of throughput. However, the material itself has low volume conductivity and tends to degrade upon exposure to ultraviolet (UV).

To create electronically conductive trace using liquid-based printing techniques for patterning and deposition of conductive inks is of great interest as it represents a much faster and lower-cost technique than traditionally gas phase deposition followed by photolithography. Inks or dispersions containing conductive fillers are printed onto various substrates in one step, therefore reducing the time, cost, and space consumed and the toxic waste created during the traditional manufacturing process. The solution processing-based method has a high rate of throughout and provides enhanced flexibility for choosing both the deposition material and substrate. Printing techniques include screen printing, flexo, gravure printing, inkjet printing etc, and also include spay by a nozzle such as ultrasonic spray nozzle.

Metal nanomaterials with sizes ranging form 1 to 200 nm are great fillers for conductive printable inks and dispersions because of their size-dependent properties such as enhanced dispersibility, greater compatibility with various chemical and physical environments due more significant effects from interchangeable surface coating. Due to their small size, nanoparticles exhibit a melting point as low as 1000° C. below the bulk material. For example, silver nanoparticles can sinter at 120° C. which is more than 800° C. below the melting temperature of bulk silver. This lower melting point is a result of comparatively high surface-area-to-volume ratio in nanoparticles, which allows bonds to readily form between neighboring particles. The large reduction in sintering temperature for nanomaterials enables forming highly conductive traces or patterns on flexible plastic substrates, because the flexible substrates of choice melt or soften at relatively low temperature (for example, 150° C.). Upon heating at relatively low temperature, the nanoparticles can sinter and form necking with each other to become a highly conductive trace. Nanoparticle inks are considered necessary where using inkjet printing, because they are small enough to be jetted without plugging the nozzle. Nanoparticles inks also provide finer line, reduced feature and higher resolution. For conductive inks, suitable metal nanoparticle fillers are silver, gold, copper, palladium, nickel, platinum, various silver alloys and other alloys of the kind. Silver is the most widely used materials for conductive inks used in printable electronics. It has the highest conductivity of any metal. It is much lower in cost than gold and possesses much better environmental stability than copper or aluminum.

To create transparent conductive film by metal nanoparticles will require aligning fine lines of the nanoparticles into porous structure (or grid network, or chickwire structure), where electrical current conducts thought the thin metal lines and the lights transmit the film through the pores. The transmittance of the lights depends on the ratio of the area coverage of the pores to the fine lines. The diameters of the fine lines are preferred to be small enough so they are nearly invisible to eyes, less than 10 μm, preferably less than 5 μm, more preferably less than 2 μm. Such porous structure can be created by the direct printing of the nanoparticle inks by a printing technique, such as screen printing or inkjet printing. However, state of the art screen or inkjet printing equipment currently limit the line resolution to about 20 μm, and they are more expensive and less throughout than more conventional gravure or flexo printing. Such porous structure can also be formed by spontaneous self-assembly of the nanoparticles, which can be controlled by the ink formulation and by drying environment.

U.S. Pat. No. 7,566,360B2 discloses a method to make such structure by printing a water-in-oil emulsion containing metal nanoparticles. The formation of structure was driven by the different evaporation rate of the two solvents used. However, 40-80 wt % of the formulation is toxic organic solvent, such as toluene, trichloroethylene etc. The use of the organic solvents not only increases the cost of the ink manufacture, more importantly, the evaporation of the organic solvent into the atmosphere severely damaged the environment.

Therefore, a need exists in the art for creating a highly conductive and transparent film by a low lost, high throughout and environmental friendly method.

### SUMMARY OF THE INVENTION

One embodiment of this invention is directed to an optically transparent and electrically conductive film consisting of a porous structure, or grid network, or chickwire structure of continuous metallic fine lines, wherein said such structure is obtained either by a direct printing technique, or by spontaneously self-assembly of a liquid thin film obtained by spray or printing. In certain embodiments, the electrical current flows through the network of the metallic lines and the lights transmit though the pores in the network. In certain embodiments, the metallic lines can be formed by sintering or fusing of the pre-existing metallic nanoparticles, or by decomposition of metal-containing precursors, or by combinations thereof. In certain embodiments, the sheet resistance of the film can be controlled between 10,000Ω/□ and 0.01Ω. In certain embodiments, the visible light transmittance of the film is in the range of 10% to 99%. In certain embodiments, the haze value of the film is range of 0.1% to 10% at 400 nm to 700 nm wavelength.

Another embodiment of the invention is directed to a method of making optically transparent and electrically conductive coatings from aqueous inks or dispersions of metal nanoparticles. Said method comprising steps of (1) admixing metal nanoparticles (or metal-containing precursors, or by combinations thereof), foam forming chemical (or bubble agent) and water with at least one ingredient of the group: foam stabilizer, humectants, adhesion promoter, binder, surfactant, additive, polymer, buffer, thickener or viscosity modifier, dispersant and/or coupling agent in a matter until a homogenized foam (or bubble-in-water dispersion or ink) is obtained; (2) applying the foam (or bubble-in-water dispersion or ink) obtained onto a substrate to form a liquid thin film; (3) developing a chickwire-like network in situ while bubble bursting and water evaporating from said homogenized dispersion; (4) sintering the coated layer so a conductive and transparent coating is obtained on the substrate.

Water is the first essential component of the present invention, generally present at a level of from 40 (wt) % to 95 (wt) %. The invented formulation does not contain any toxic organic solvent. A small amount of water-miscible, environmental friendly solvent (may (not necessary) be used as a secondary solvent.

It is further in the scope of the present invention wherein the metal nanoparticles are water soluble. The metal nanoparticle is capped with hydrophilic surfactants and can readily go to aqueous phase. The metal nanoparticle is not soluble in non-polar organic solvent.

It is further in the scope of the present invention wherein the metal nanoparticles can be replaced by, or mixed with, metal-containing precursor. The said metal-containing precursor is selected from (but not limited to) metal colloids and/or organic metal compound and/or organic metal complex and/or metal reducible salts which can decompose to form conductive metals.

It is further in the scope of the present invention wherein the foam forming chemical (or foam boosting agent, or bubble agent) is soluble in water or secondary solvent (if applied). Preferably, the weight percentage of the foam forming chemical is between 0.1 (wt) % to 10 (wt) %, more preferably, between 1 (wt) % to 6 (wt) %. The foam forming chemical (or foam boosting agent, or bubble agent) is selected from (not limited to) anionic, cationic, organic amine or metallic soaps, or combination thereof. The foam forming chemical can also be selected from commercially available various foaming boosting agents.

It is further in the scope of the present invention wherein humectants, thickeners and viscosity modifiers, other surfactants, and adhesion promoter may be present the foam dispersion.

It is further in the scope of the present invention wherein the foam (or bubble-in-water dispersion or ink) is formed under means of vigorous agitation, by ultrasonic energy, or under the emitting effect of propellant from aerosol container.

It is further in the scope of the present invention wherein the liquid thin film coated on the substrates obtained by a printing technique or by spray.

In certain embodiments, the substrate to be coated is either flexible or rigid, selected from (but not limited to) glass, ceramic, paper, metal, printed circuit boards, epoxy resins, polymeric film or sheet or any combination thereof.

It is further in the scope of the present invention wherein the chickwire-like film formed after self-assembly will be sintered to become electrically conductive. The sinter method can be selected from (not limited to) thermal sintering, chemical sintering, UV curing, etc.

Other embodiments and advantages of the invention are set forth in part in the description, which follows, and in part, may be obvious from this description or may be learned from the practice of the invention.

### DETAILED DESCRIPTION OF THE FIGURES

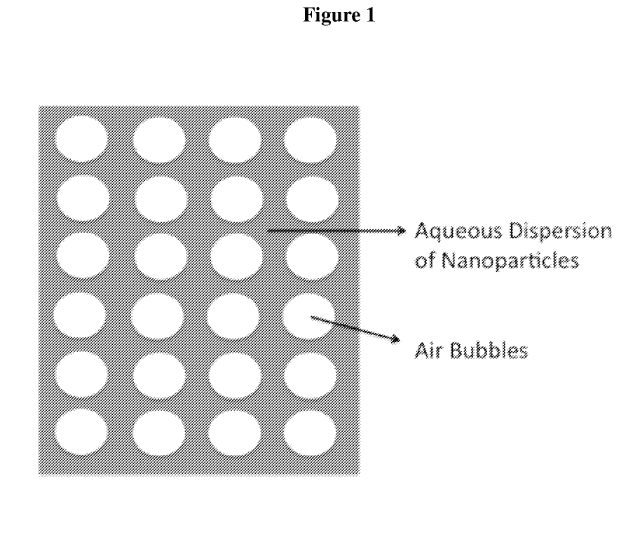

FIG. 1 shows a schematic diagram of the foam (or bubble-in-water dispersion or ink) with silver nanoparticles dispersed in the aqueous phase.

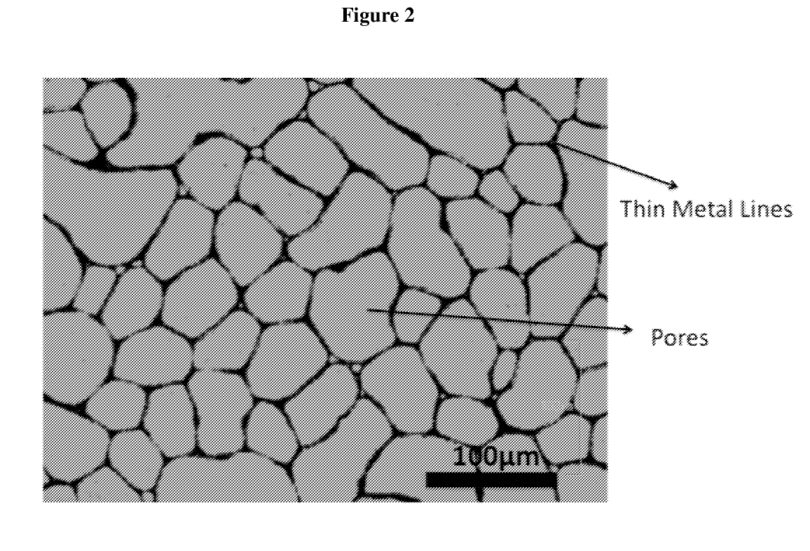

FIG. 2 shows a representative picture taken by a means of a light microscope showing the chickwire-like network spontaneously formed on glass by the self-assembly of the silver nanoparticles dispersion obtained by the method of one embodiment of the present invention.

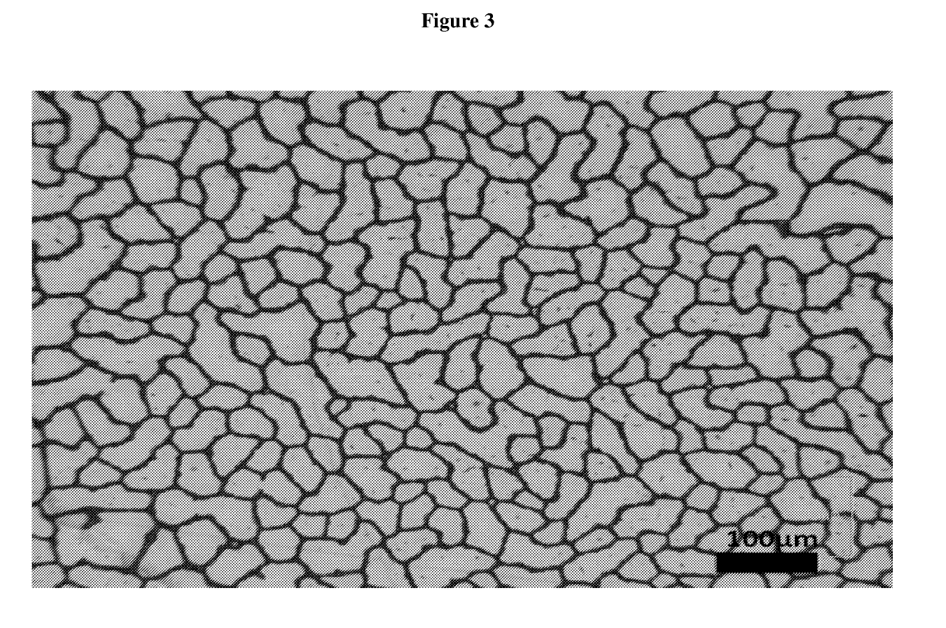

FIG. 3 shows a representative picture taken by a means of a light microscope showing the chickwire-like network spontaneously formed on polyethylene terephthalate (PET) by the self-assembly of the silver nanoparticles dispersion obtained by the method of one embodiment of the present invention.

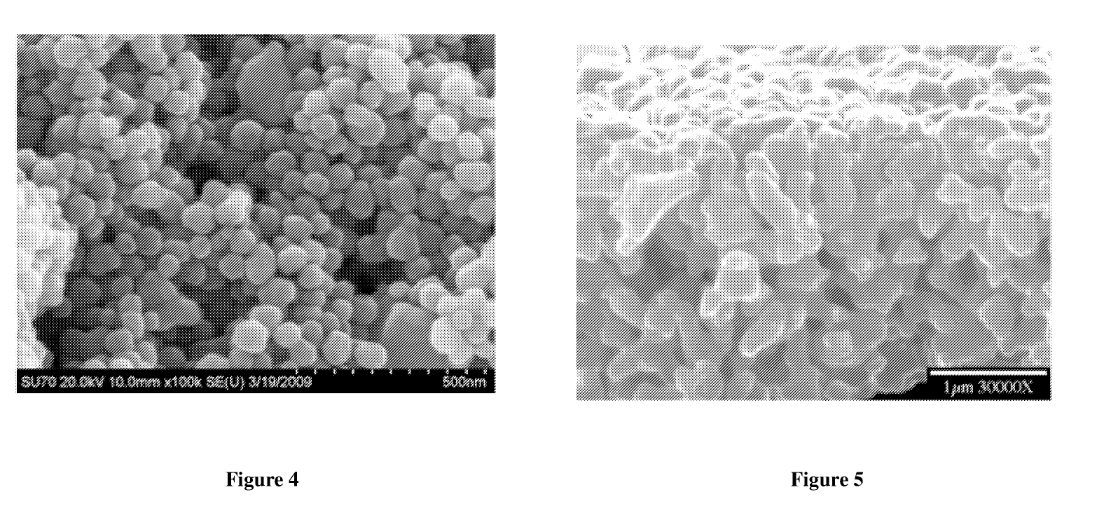

FIG. 4 shows scanning Electron Microscopy Photographs of representative nanoparticles before and after thermal sintering.

FIG. 5 shows scanning Electron Microscopy Photographs of representative nanoparticles before and after thermal sintering.

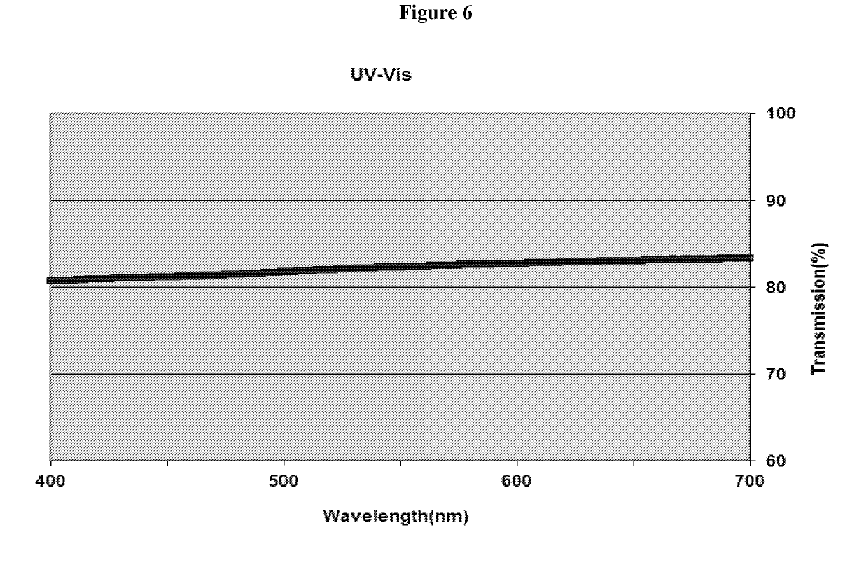

FIG. 6 shows an illustration of the light transparency of the film obtained by method of one embodiment of the present invention measured by ultraviolet-visible spectroscopy.

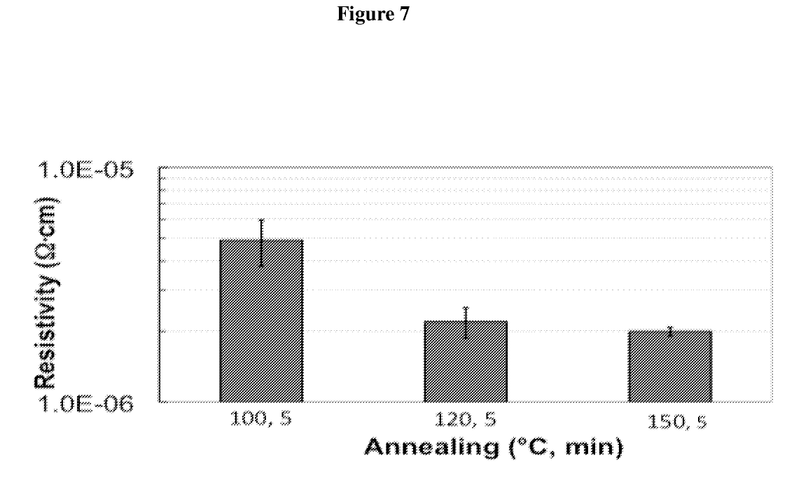

FIG. 7 shows an illustration of the relative resistance of the film obtained by method of one embodiment of the present invention dependence on annealing temperature.

### DETAILED DESCRIPTION OF THE INVENTION

One embodiment of this invention is directed to an optically transparent and electrically conductive film consisting of a porous structure, or grid network, or chickwire structure of continuous metallic fine lines, wherein said such structure is obtained either by a direct printing technique, or by spontaneously self-assembly of a liquid thin film obtained by spray or printing. In certain embodiments, the electrical current flows through the network of the metallic lines and the lights transmit though the pores in the network. In certain embodiments, the metallic lines can be formed by sintering or fusing of the pre-existing metallic nanoparticles, or by decomposition of metal-containing precursors, or by combinations thereof. In certain embodiments, the sheet resistance of the film can be controlled between 10,000Ω/□ and 0.01Ω/□, preferably below 100Ω/□, more preferably below 20Ω/□. In certain embodiments, the visible light transmittance of the film is in the range of 10% to 99%, preferably greater than 70%, more preferably greater than 80%. In certain embodiments, the haze value of the film is range of 0.1% to 10% at 400 nm to 700 nm wavelength. In certain embodiments, the diameter of the fine line is less than 20 μm, preferably less than 10 μm, more preferably less than μm, further preferably less than 2 μm. In certain embodiments, the ratio of the area coverage of the pores to the metallic lines is more than 70%, preferably more than 80%, more preferably more than 90%.

Another embodiment of the invention is directed to a method of making optically transparent and electrically conductive coatings from aqueous inks or dispersions of metal nanoparticles. Said method comprising steps of:
1. admixing metal nanoparticles (or metal-containing precursors, or by combinations thereof), foam forming chemical (or bubble agent) and water with at least one ingredient of the group: foam stabilizer, humectants, adhesion promoter, binder, surfactant, additive, polymer, buffer, thickener or viscosity modifier, dispersant and/or coupling agent in a matter until a homogenized foam (or bubble-in-water dispersion or ink) is obtained;
2. applying the foam (or bubble-in-water dispersion or ink) obtained onto a substrate to form a liquid thin film;
3. developing a chickwire-like network in situ while bubble bursting and water evaporating from said homogenized dispersion;
4. sintering the coated layer so a conductive and transparent coating is obtained on the substrate.

TABLE 1
Basic formulation of the foam (or bubble-in-water dispersion)
described and defined in the present invention.

| | Min. content, | Max. content, |
|---|---|---|
| Component | wt % | wt % |
| Water | 60 | 90 |
| Metal Nanoparticle or metal | 10 | 40 |
| containing precursor | | |
| Foam forming chemical | 0.1 | 10 |
| Secondary solvent | 0 | 10 |
| thickener and viscosity | 0 | 2 |
| modifier | | |
| surfactant | 0 | 3 |
| humectants | 0 | 2 |
| adhesion promoter | 0 | 3 |

It is further in the scope of the present invention wherein water, preferably distilled or deionized, is generally present at a level of from 40 (wt) % to 95 (wt) %, preferably between 60 (wt) % to 90 (wt) %.

It is further in the scope of the present invention wherein the admixed solution does NOT contain any toxic organic solvent, selected from (not limited to) at least one of the group of petroleum ether, hexanes, heptanes, toluene, benzene, dichloroethane, trichloroethylene, chloroform, dichloromethane, nitromethane, dibromomethane, cyclopentanone, cyclohexanone, or any mixture thereof.

It is further in the scope of the present invention wherein a water-miscible solvent may (not necessary) be used as a secondary solvent. Secondary solvent is used to promote foam (or bubble) formation and facilitate drying. The secondary solvent is usually alcohol based solvent, selected from (not limited to) ethanol, methanol, ethyl alcohol, 2-methoxyethanol etc. Generally, the weight percentage of the secondary solvent is between 0 (wt) % to 10 (wt) %, preferably between 0 (wt) % to 5 (wt) %.

It is further in the scope of the present invention wherein the metal nanoparticles are water soluble, can readily go to aqueous phase or other polar solvents. The surface of the metal nanoparticle is capped with hydrophilic surfactants, selected from (not limited to) gum arabic, ammonium stearate and other stearate salts, Daxad 19, Solsperse, polyethylene glycol, polyvinyl pyrrolidone, polyvinyl alcohol and thereof, cellulose derivatives (e.g. carboxymethyl cellulose, carboxyethyl cellulose, methyl cellulose, etc.) and modified products thereof, polyacrylamide and copolymers thereof, acrylic acid copolymers, vinylmethyl ether-maleic anhydride copolymers, vinyl acetate-maleic anhydride copolymers, various salts of naphthalene sulphonic-formaldehyde copolymers, styrene-maleic anhydride copolymers, calcined dextrin, acid-decomposed dextrin, acid-decomposed etherified dextrin, agarose, and salmon sperm DNA. The metal nanoparticles are not soluble in non-polar solvent, selected from (not limited to) at least one of the group of petroleum ether, hexanes, heptanes, toluene, benzene, dichloroethane, trichloroethylene, chloroform, dichloromethane, nitromethane, dibromomethane, cyclopentanone, cyclohexanone, or any mixture thereof.

It is further in the scope of the present invention wherein the metal nanoparticles can be replaced by, or mixed with, metal-containing precursor. The said metal-containing precursor is selected from (but not limited to) metal colloids and/or organic metal compound and/or organic metal complex and/or metal reducible salts which can decompose to form conductive metals. For example, in case of silver, the metal-containing precursor can be silver formate, silver acetate, silver halide, silver oxalate, etc. In certain embodiments, the metal or mixture of metals (including alloys) is gold, silver, palladium, platinum, copper, chromium, nickel, cobalt, manganese, iron, aluminum, an alkaline earth metal, an alkali metal, a transition metal, a lanthanide, a poor metal, an actinide, or combinations thereof. Preferably, the weight percentage of metal nanoparticle (or metal-containing precursors, or by combinations thereof) in the homogenized dispersion is between 5 (wt) % to 60 (wt) % and more particularly, in the range of 10 (wt) % to 40 (wt) %.

It is further in the scope of the present invention wherein the foam forming chemical (or foam boosting agent, or bubble agent) is soluble in water or secondary solvent (if applied). Preferably, the weight percentage of the foam forming chemical is between 0.1 (wt) % to 10 (wt) %, more preferably, between 1 (wt) % to 6 (wt) %.

The foam forming chemical (or foam boosting agent, or bubble agent) is selected from (not limited to) anionic, cationic, organic amine or metallic soaps, or combination thereof. Examples of suitable anionic foam forming chemical include alkali soaps, such as sodium potassium and ammonium salts of aliphatic carboxylic acids, such as sodium stearate. Other classes of suitable anionic foam forming chemical include sulfated fatty acid alcohols such as sodium lauryl sulfate, sulfated oils such as the sulfuric ester of ricinoleic acid disodium slat, and sulfonated compounds such as alkyl sulfonates including sodium cetane sulfonate, amide sulfonates such as sodium N-methyl-N-oleyl laurate, sulfonated dibasic acid esters such as sodium dioctyl sulfosuccinate, alkyl aryl sulfonates such as sodium dedecylbenzene sulfonate, alkyl naphthalene sulfonates such as sodium isopropyl naphthalene sulfonate, petroleum sulfonate such as aryl naphalene with alkyl substitutes. Examples of anionic foam forming chemical also include sodium lauryl ether sulfate, sodium laureth sulfate, and sodium cocamphodiacetate. Examples of suitable cationic foam forming chemical include amine salts such as octadecyl ammonium chloride, quarternary ammonium compounds such as benzalkonium chloride. Examples of organic amine soaps include organic amine salts of aliphatic carboxylic acids, usually fatty acids, such as triethanolamine state. Examples of suitable metallic foam forming chemical include salts of polyvalent metals and aliphatic carboxylic acids such as aluminum stearate.

The foam forming chemical can also be selected from commercially available various foaming boosting agent from Mason Chemical Company, such as Macare® G-2C, MACAT AO-12-2, Macat AO-14, Macat® AO-16, Macat® AO-18:1, Macat® LB/CB/LCB, Macat® LFB, Macat® MCO, Macat® OB, Macat® Ultra CDO, Macat® Ultra CG & Ultra CG-50, Macat Ultra CDO, Macat Ultra CG, Macat LFB, Masamide R-4, Macat AEC-126, Masamide® R-4, Masurf® AF-110DE Masurf® AF-410TE, Masurf® FS-115/FS-130, Macare® Glycereth Cocoates (Masurf G-2C, Masurf G-7C, Masurf G-17C), or combination thereof. Examples of foam forming chemical include Quaternium-26, also known as mink amido-propyl dimethyl2-(hydroxyethyl) ammonium chloride.

It is further in the scope of the present invention wherein humectants can be added to the foam dispersion. Humectants can be selected from (but not limited to) glycerol, glycerine, propylene glycol (E1520), glyceryl triacetate (E1518), diethylene glycol, triethanolamine, Dowanol DB, dimethyl formamide, isopropanol, n-propanol, 1-methoxy-2-propanol, 1-methylpyrrolidinone. Others can be polyols like sorbitol (E420), xylitol and maltitol (E965), polymeric polyols like polydextrose (E1200), or natural extracts like quillaia (E999), lactic acid or urea. Preferably, the weight percentage of the humectants is between 0 (wt) % to 2 (wt) %, more preferably, between 0.1 (wt) % to 1 (wt) %.

It is further in the scope of the present invention wherein thickeners and viscosity modifiers can be added to the foam formulation to modify the viscosity of the form for best printing result. Thickeners and viscosity modifiers can be selected from (but not limited to) Cocamidopropyl Betaine, diethanolamide of a long chain fatty acid, fatty alcohols (i.e. cetearyl alcohol). Preferably, the weight percentage of thickeners and viscosity modifiers is between 0 (wt) % to 2 (wt) %, more preferably, between 0.2 (wt) % to 1 (wt) %.

It is further in the scope of the present invention wherein surfactants can be added to the foam formulation to decrease dry time and increase wetting of ink on media. Surfactants are preferred to be water soluble, selected from (not limited to) Solspers series from Lubrizol such as Solspers 2000, Synperonic 91/6 and Atlox 4913 from Croda, Tamol 1124 from Dow Chemicals, or any combination thereof. Examples of surfactants include BASF 104, Joncryl 537, Joncryl 8003 from BASF. Examples of surfactants include Surfynol series from Air Products such as Surfynol 465, which is an ethoxylated 2,4,7,9-tetramethyl 5 decyn-4,7-diol. Preferably, the weight percentage of the surfactants is between 0 (wt) % to 3 (wt) %, more preferably, between 0.2 (wt) % to 1 (wt) %.

It is further in the scope of the present invention wherein adhesion promoter may be present in the foam formulation. Adhesion promoter is selected from (not limited to) cationic dispersion of styrene-acrylic ester copolymer such as Cartacoat B750 Liquid manufactured by Clariant, polyethyleneimine, arabinogalactan, etc. Preferably, the weight percentage of the foam forming chemical is between 0 (wt) % to 3 (wt) %, more preferably, between 0.1 (wt) % to 1 (wt) %.

It is further in the scope of the present invention wherein the foam (or bubble-in-water dispersion or ink) is formed under means of vigorous agitation, which include mixing by sonication bath or ultrasonic horn, or by high rpm dispersing equipment, such as homogenizer, speed mixer, vortex etc. The foam can also form in situ by spray (e.g. by ultrasonic spray nozzle or aerosol) or under the emitting effect of propellant from container. The propellant is selected from (but not limited to) isobutene, n-butane, propane, dimethylether, trichlorotrifluoroethane, etc.

It is further in the scope of the present invention wherein the liquid thin film coated on the substrates obtained by a printing technique or by spray. In certain embodiments, the printing technique is selected from (but not limited to) dipping, immersing, simple spreading, spreading by applicator, rod spreading, bar spreading, wet coating, spin coating, gravure printing, flexography, screen printing, offset printing, inkjetting, or spray coating by an ultrasonic nozzle. In certain embodiments, the wet thickness of liquid coating is 1 to 300 μm, more preferably, 5-100 μm.

In certain embodiments, the substrate to be coated is either flexible or rigid, selected from (but not limited to) glass, ceramic, paper, metal, printed circuit boards, epoxy resins, polymeric film or sheet or any combination thereof. More specifically, the polymeric film comprises at least one of the groups of polyesters (e.g. polyethylene terephthalate, polyolefins), polyamides, polypropylene, polyimides, polycarbonate, polymethyl methacrylate, polyethylene, acrylate-containing products, their copolymers or any combination thereof, or any other transparent or printable substrate.

It is further in the scope of the present invention wherein the chickwire-like film formed after self-assembly will be sintered to become electrically conductive. The sinter method can be selected from (not limited to) thermal sintering, chemical sintering, UV curing, etc. Thermal sintering is provided in the temperature range of 40° C. to 300° C. for 0.5 minutes to 120 minutes, more specifically, in the range of 80° C. to 150° C. for 2 minutes to 30 minutes. Chemical sintering is conducted under a chemical that can induce the sintering process in the temperature range of 20° C. to 150° C. for 2 minutes to 30 minutes. Suitable chemical is selected from (but not limited to) hydrochloric acid, nitric acid, sulfuric acid, formic acid, acetic acid, formaldehyde etc. The film can be dipped into the solution containing said chemical or be sprayed on the surface by the said chemical.

The foam composition (or bubble-in-water dispersion), in which nanoparticles dispersed in the aqueous phase, is applied, preferably by ultrasonic spray nozzle, onto the surface of the substrate. FIG. 1 illustrates the thin film of such foam (or bubble-in-water dispersion).

FIGS. 2 and 3 illustrate the chickwire-like network spontaneously formed by the self-assembly of the nanoparticles inks while evaporating water from the foam thin film.

FIGS. 4 and 5 illustrate nanoparticles before and after sintering. After sintering, nanoparticles fused together and formed necking to become electrically conductive.

The invention will be better understood by reference to the Experimental Details which follow, but those skilled in the art will readily appreciate that the specific experiments detailed are only illustrative, and are not meant to limit the invention as described herein, which is defined by the claims which follow thereafter.

Throughout this application, various references or publications are cited. Disclosures of these references or publications in their entireties are hereby incorporated by reference into this application in order to more fully describe the state of the art to which this invention pertains. It is to be noted that the transitional term “comprising”, which is synonymous with “including”, “containing” or “characterized by”, is inclusive or open-ended and does not exclude additional, un-recited elements or method steps.

### Example 1

### Transparent Conductive Coating on Glass

Admix metal nanoparticles (silver nanoparticles, average particle size 80 nm), 10 g; water, 42.2 g; a foam forming chemical (Macare® G-2C), 2.2 g; a viscosity modifier (cocamidopropyl betaine), 0.28 g; a surfactant (Synperonic 91/6), 0.55 g; an adhesion promoter (Cartacoat B750), 0.28 g. Then homogenizing the obtained solution by ultrasonic energy (ultrasonic horn) for 2 minutes until a foam (bubble-in-water dispersion) formed. Spray the obtained homogenized foam solution onto the surface of glass by ultrasonic spray nozzle. This formulation gave a good developed chickwire-like network with pore sizes of 30 μm to 100 μm and Ag lines with 2 μm to 5 μm width. Reference is made now to FIG. 2, presenting a view taken by a means of a light microscope showing the chickwire-like network on a glass surface as obtained by the method as described in Example 1. This film has over 80% transparency in the range of 400 nm to 700 nm, as shown in FIG. 6, measured by ultraviolet-visible spectroscopy. Resistivity was 7.8μΩ·cm, 3.0μΩ·cm, 2.3μΩ·cm, respectively, after sintering at 100° C., 120° C. or 150° C. for 5 minutes, as shown in FIG. 7.

### Example 2

### Transparent Conductive Coating on PET

Admix metal nanoparticles (silver nanoparticles, average particle size 30 nm), 8 g; water, 38.3 g; a foam forming chemical (Masurf G-2C), 2.7 g; a secondary solvent (ethanol), 2.7 g; a viscosity modifier (glycerol), 0.27 g; a surfactant (Surfynol 465), 0.91 g; a humectant, 0.27 g; an adhesion promoter(arabinogalactan), 0.27 g. Then homogenizing the obtained solution by ultrasonic energy (ultrasonic horn) for 2 minutes until a foam (bubble-in-water dispersion) formed. Spray the obtained homogenized foam solution onto the surface of polyethylene terephthalate (PET) by ultrasonic spray nozzle. This formulation gave a good developed chickwire-like network with pore sizes of 20 μm to 120 μm and Ag lines with 2 μm to 10 μm width. Reference is made now to FIG. 3, presenting a view taken by a means of a light microscope showing the chickwire-like network on a PET surface as obtained by the method as described in Example 2. This film has over 75% transparency in the range of 400 nm to 700 nm, measured by ultraviolet-visible spectroscopy. Resistance was 2Ω/□ after sintering at 150° C. for 5 minutes.

What is claimed is:

1. A composition for forming transparent conductive coating, the composition comprising 50-95% by weight of water, 5-60% by weight of metal nano-particles or metal-containing precursors, and 0.1-10% by weight of foam forming chemical or bubble agent.

2. The composition of claim 1, wherein the metal nanoparticles or metal-containing precursors are water soluble, and not soluble in non-polar organic solvent.

3. The composition of claim 1, wherein the metal nanoparticles or metal-containing precursors are capped with hydrophilic surfactants.

4. The composition of claim 3, wherein the hydrophilic surfactants are selected from the group consisting of gum arabic, ammonium stearate, stearate salts, polyethylene glycol, polyvinyl pyrrolidone, polyvinyl alcohol, cellulose derivatives, polyacrylamide and copolymers thereof, acrylic acid copolymers, vinylmethyl ether-maleic anhydride copolymers, vinyl acetate-maleic anhydride copolymers, salts of naphthalene sulphonic-formaldehyde copolymers, styrene-maleic anhydride copolymers, calcined dextrin, acid-decomposed dextrin, acid-decomposed etherified dextrin, agarose, and salmon sperm DNA.

5. The composition of claim 1, wherein the metal nanoparticles have an average size of 1 nm to 500 nm.

6. The composition of claim 1, wherein the metal nanoparticles or metal-containing precursors comprise a metal element selected from the group consisting of gold, silver, palladium, platinum, copper, chromium, nickel, cobalt, manganese, iron, aluminum, an alkaline earth metal, an alkali metal, a transition metal, a lanthanide, a poor metal, an actinide, and combinations thereof.

7. The composition of claim 1, wherein the metal-containing precursors are selected from the group consisting of metal colloids, organic metal compound, organic metal complex, and metal reducible salts which can decompose to form conductive metals.

8. The composition of claim 7, wherein the metal-containing precursors are selected from the group consisting of silver formate, silver acetate, silver halide, and silver oxalate.

9. The composition of claim 1, wherein the composition comprises 60% to 90% by weight of water.

10. The composition of claim 1, wherein the composition comprises 10% to 40% by weight of metal nano-particles or metal-containing precursors.

11. The composition of claim 1, wherein the composition comprises 1% to 6% by weight of foam forming chemical or bubble agent.

12. The composition of claim 1, wherein the foam forming chemical or bubble agent is selected from the group consisting of anionic foam forming chemical, cationic foam forming chemical, organic amine soaps, and metallic foam forming chemical.

13. The composition of claim 1, wherein the composition further comprises up to 10% by weight of a water-miscible secondary solvent.

14. The composition of claim 13, wherein the water-miscible secondary solvent is selected from the group consisting of ethanol, methanol, and ethyl alcohol.

15. The composition of claim 1, wherein the composition further comprises an agent selected from the group consisting of foam stabilizer, humectant, adhesion promoter, binder, surfactant, additive, polymer, buffer, thickener or viscosity modifier, dispersant, coupling agent, and combination thereof.

16. The composition of claim 15, wherein the humectant constitutes up to 2% by weight of the composition.

17. The composition of claim 15, wherein the thickener or viscosity modifier constitutes up to 2% of the composition.

18. The composition of claim 15, wherein the surfactant constitutes up to 3% by weight of the composition.

19. The composition of claim 1, wherein the adhesion promoter constitutes up to 3% by weight of the composition.
